(19) United States
(12) Patent Application Publication
(10) Pub. No.: US 2006/0027176 A1
(43) Pub. Date: Feb. 9, 2006

(54) Animal feeding device and liner

(76) Inventors: Marilyn S. McQuade, Rocky River, OH (US); Joan A. Pang, Chagrin Falls, OH (US); Gordon Pang, Chagrin Falls, OH (US); Kevin M. McQuade, Rocky River, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/145,723

(22) Filed: Jun. 6, 2005

Related U.S. Application Data
(60) Provisional application No. 60/576,971, filed on Jun. 4, 2004.

(51) Int. Cl. A01K 5/01

(52) U.S. Cl. 119/61.5

(57) ABSTRACT

An animal feeding system includes a feeding receptacle and a disposable liner releasably attached to the feeding receptacle. The receptacle includes a bottom wall and a sidewall, which define an internal cavity. The receptacle includes a rim around and extending outwardly from an upper portion of the sidewall. At least one engagement member attached to or formed with at least one of the sidewall and the rim. The disposable liner is sized to fit within the receptacle, and includes a bottom wall and a sidewall which define an internal cavity, a rim around and extending outwardly from an upper portion of the sidewall, the rim including a pair of flange portions extending outwardly from opposing sides of the rim. A pair of engagement portions is disposed within the flange portions and releasably engages the engagement members of the receptacle.

### RELATED APPLICATION DATA

This application claims benefit of U.S. Provisional Application No. 60/576,971, filed Jun. 4, 2004, which is incorporated herein by reference in its entirety.

### TECHNICAL FIELD

The present invention relates generally to animal feeding accessories and devices and, more particularly, to an animal feeding bowl and a disposable liner for receiving animal food or drink.

### BACKGROUND

Animal pets, such as dogs and cats, are usually fed from a bowl-shaped container made of plastic, metal or ceramic materials. Typically, these feeding containers include a form of a receptacle that is sized to receive dry food, wet food and/or plain liquid. Often the animal does not completely finish the food placed in the feeding container. Unless the leftover food is immediately removed by washing, it tends to adhere to the surface of the container, decays and becomes relatively difficult to remove by usual washing methods.

In addition, accumulated and aged food or liquid can often become contaminated or otherwise bacteria infested, which can result in fowl smells, generally unsanitary conditions for any animal being fed using such a container, as well as inconvenience to pet caretakers.

In response to this problem, several designs for pet dishes have been proposed. Some of these proposed designs include disposable pet dishes or disposable liners for non-disposable pet dishes. However, many of these proposed designs suffer from a number of shortcomings, such as difficulties with the liner coming loose prematurely, high production costs, difficulties in the packaging of the liners and general ineffectiveness.

Accordingly, a need exists for an improved animal feeding system that demonstrates improved performance, cost efficiency and manufacturing simplicity.

### SUMMARY OF THE INVENTION

In accordance with one aspect of the invention, a feeding system includes a feeding receptacle having a bottom wall and a sidewall which define an internal cavity. The feeding receptacle includes a rim around and extending outwardly from an upper portion of the sidewall and at least one engagement member attached to or formed with at least one of the sidewall and the rim.

In accordance with another aspect of the invention, a disposable liner for an animal feeding device includes a bottom wall and a sidewall, which define an internal cavity, a rim around and extending outwardly from an upper portion of the sidewall, the rim including a pair of flange portions extending outwardly from opposing sides of the rim; and a pair of engagement portions disposed within the flange portions.

The foregoing and other features of the invention are hereinafter more fully described and particularly pointed out in the claims, the following description setting forth in detail certain illustrative embodiments of the invention, these being indicative, however of but a few of the various ways in which the principles of the invention may be employed.

### BRIEF DESCRIPTION OF THE DRAWINGS

These and further features of the present invention will be apparent with reference to the following description and drawings, wherein:

FIG. 1 is an exploded perspective view showing of an animal feeding system in accordance with one embodiment of the invention;

FIG. 2 is a side view of an animal feeding receptacle in accordance with one embodiment of the present invention;

FIG. 3 is a top view of the animal feeding receptacle shown in FIG. 2;

FIG. 4 is an enlarged view of a portion of FIG. 3;

FIG. 5 is a side view of a liner in accordance with one embodiment of the invention;

FIG. 6 is a top view of the liner shown in FIG. 5;

FIG. 7 is an enlarged view of a portion of FIG. 6;

FIG. 8 shows side and perspective views of a plurality of exemplary liner engagement members and corresponding cooperative receptacle engagement portions in accordance with the invention;

FIG. 9 is a side view of an animal feeding system in accordance with another embodiment of the invention;

FIG. 10 is a side view of an animal feeding system in accordance with an embodiment of the invention;

FIG. 11 is a perspective view of a liner for use with a cooperative adhesive patch in accordance with one embodiment of the invention;

FIG. 12 is a side view of an animal feeding system in accordance with an embodiment of the invention;

FIG. 13 is a side view of an animal feeding system in accordance with an embodiment of the invention;

FIG. 14 is a side view of a liner in accordance with an embodiment of the invention;

FIG. 15 is an exploded perspective view showing an animal feeding system in accordance with an embodiment of the invention;

FIG. 16 is an exploded perspective view showing an animal feeding system in accordance with an embodiment of the invention;

FIG. 17 is an exploded perspective view showing an animal feeding system in accordance with an embodiment of the invention;

FIG. 18 is an exploded perspective view showing an animal feeding system in accordance with an embodiment of the invention; and

FIG. 19 is an exploded perspective view showing an animal feeding system in accordance with an embodiment of the invention.

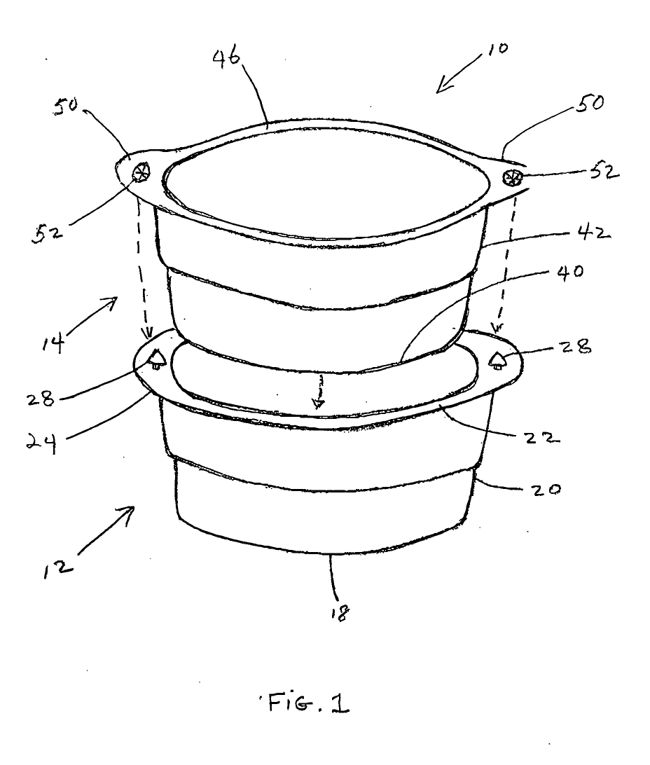

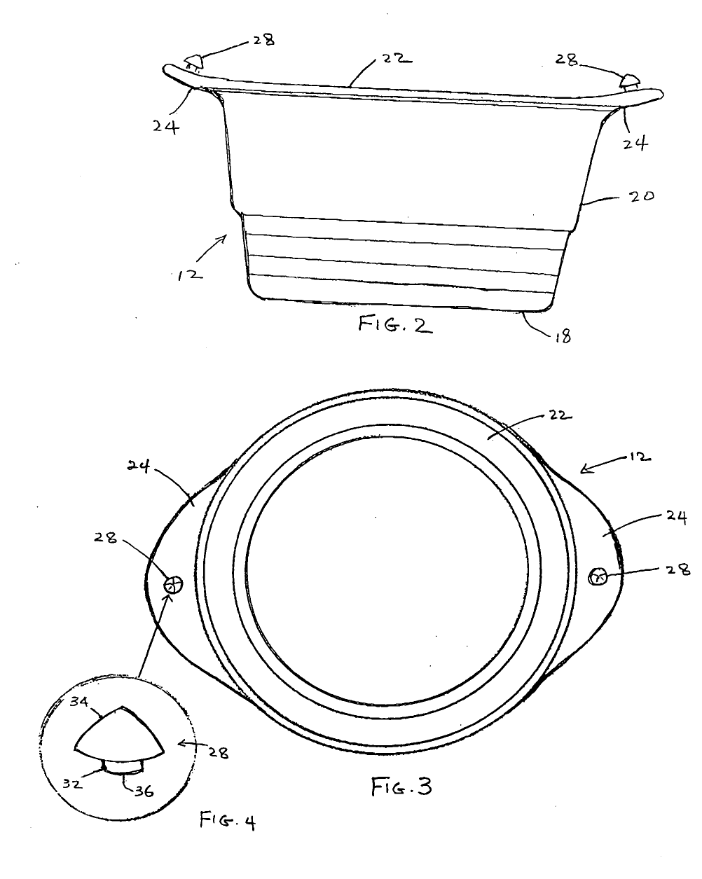

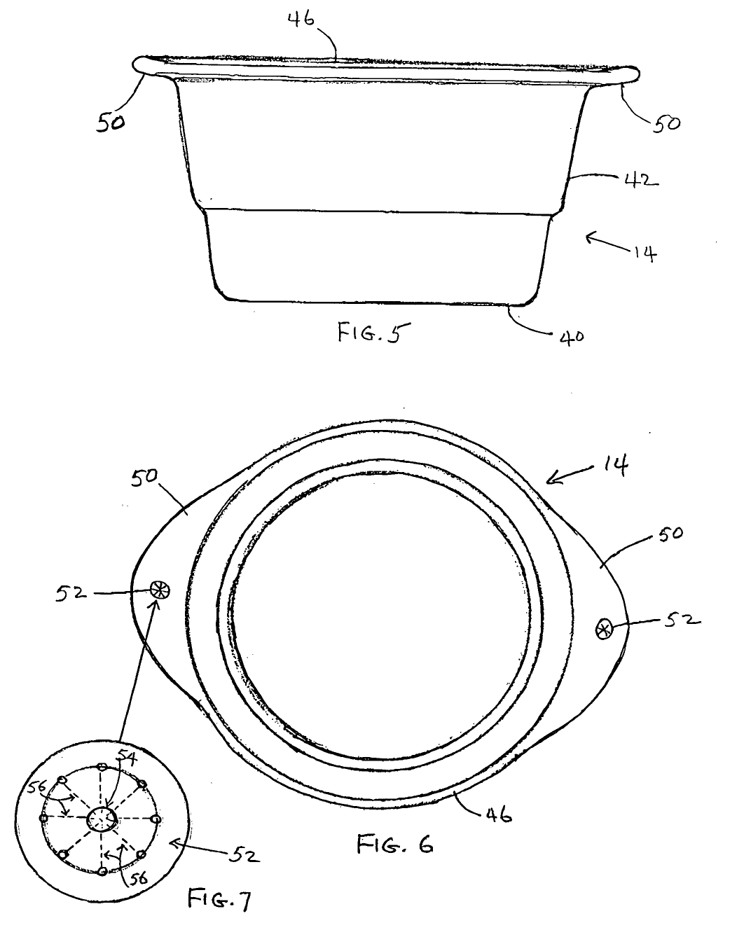

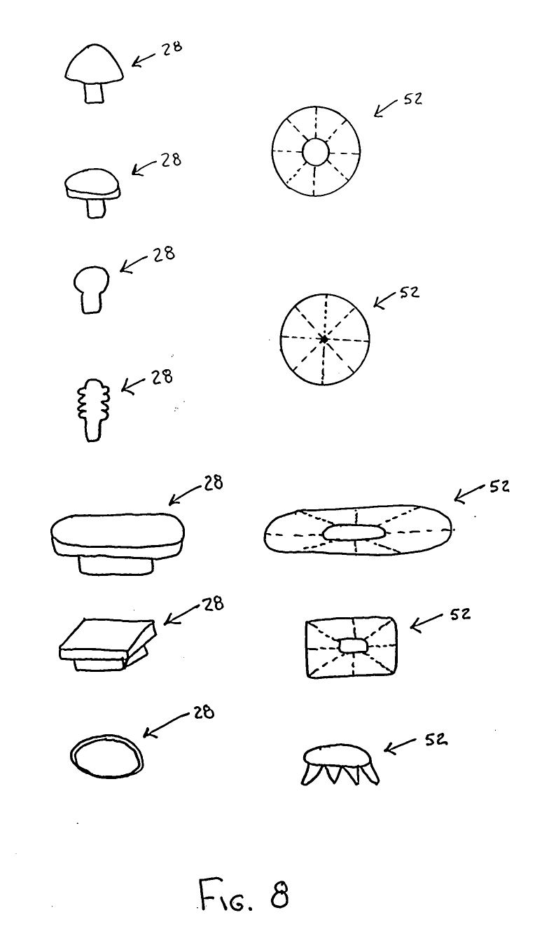

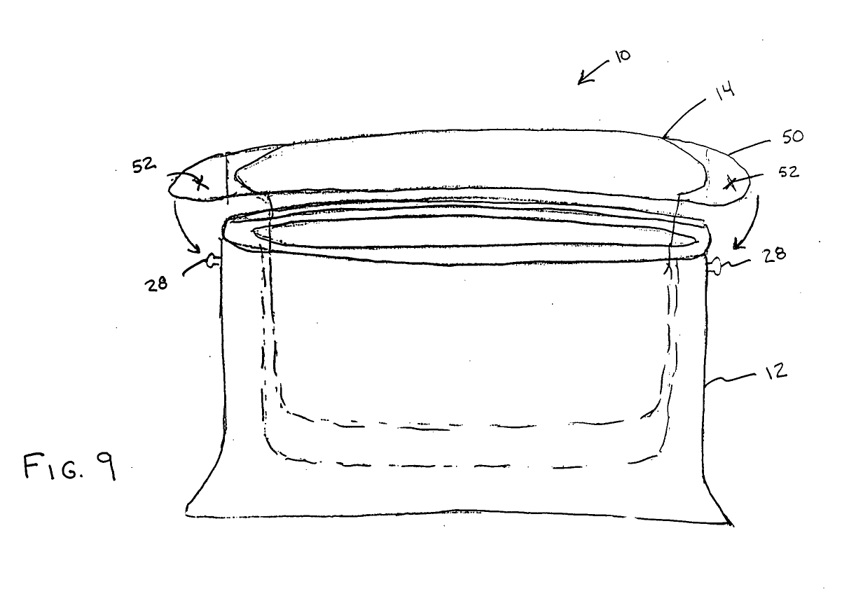

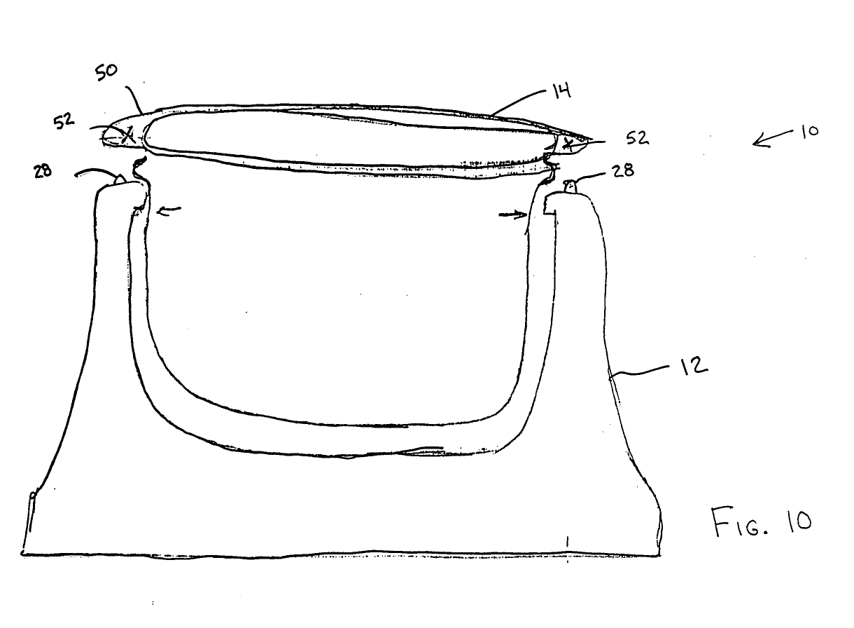

### DISCLOSURE OF INVENTION

In the detailed description that follows, corresponding components have been given the same reference numerals regardless of whether they are shown in different embodiments of the present invention. To illustrate the present invention in a clear and concise manner, the drawings may not necessarily be to scale and certain features may be shown in somewhat schematic form.

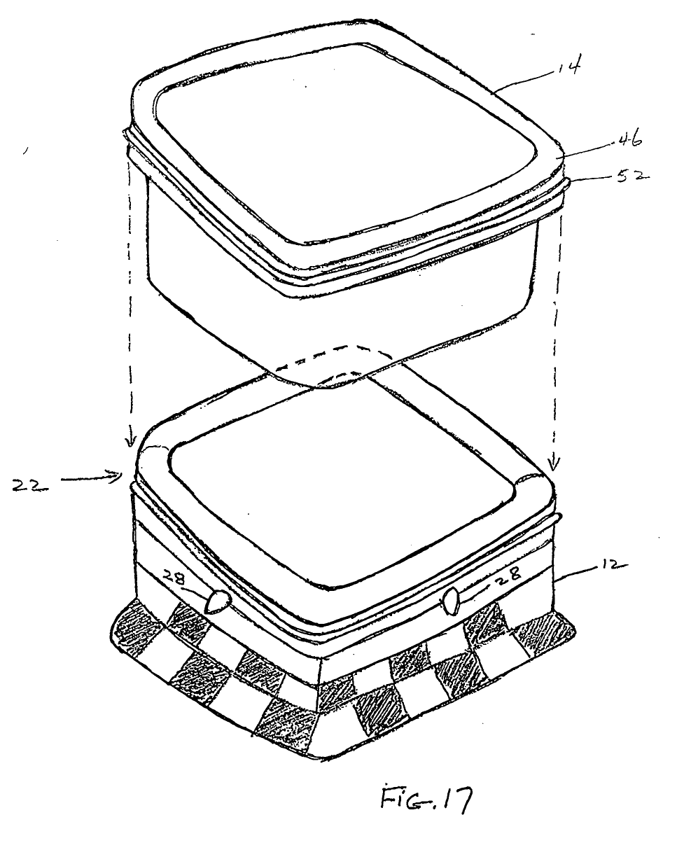

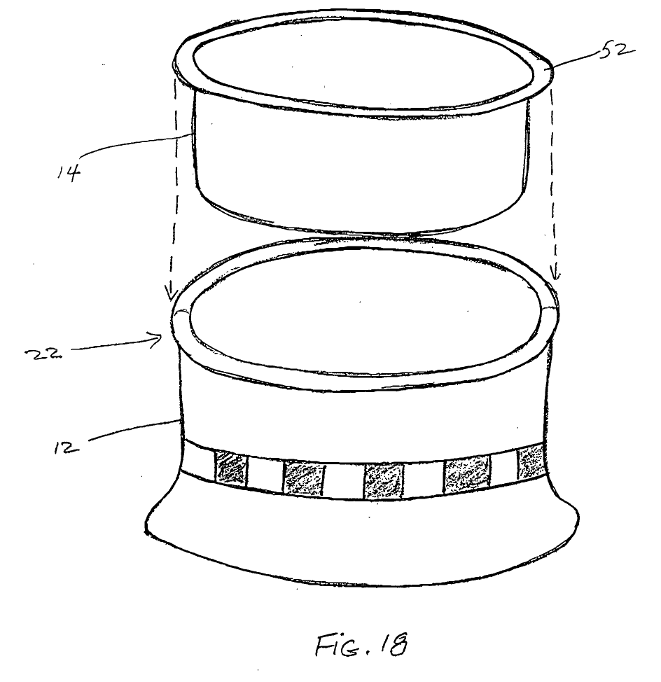

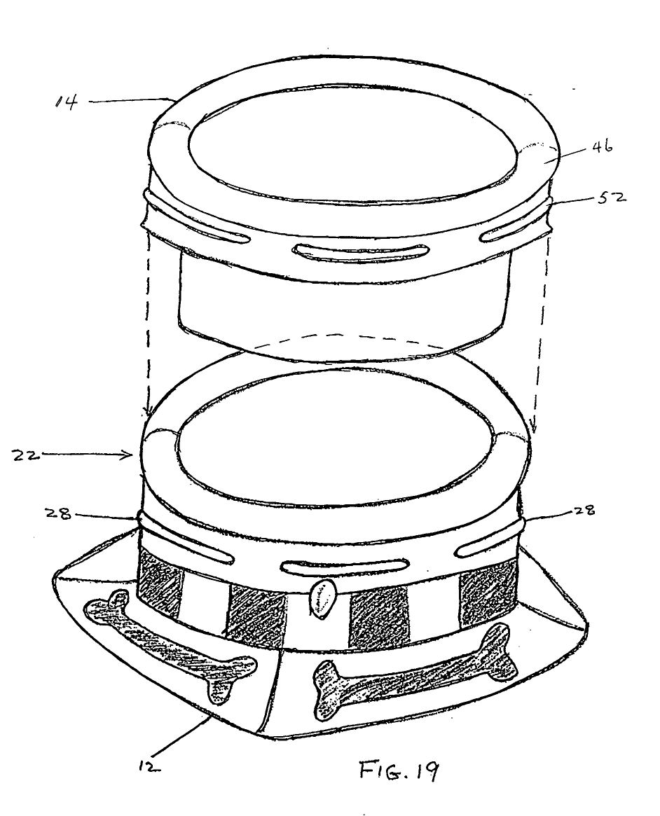

An exemplary animal feeding system according to the present invention is indicated generally by reference numeral 10 in the accompanying drawings. The feeding system includes a feeding receptacle 12 (e.g., a bowl-shaped container) and a disposable liner 14 releasably attached to or releasably engaging the receptacle 12. It is to be appreciated that the receptacle can be of any suitable size and geometry without departing from the scope of the present invention. For example, a larger receptacle, e.g., having a diameter of about 8 inches to about 15 inches (or larger or smaller), may be employed for feeding a larger dog, while a smaller receptacle, e.g., having a diameter of about 4 inches to about 8 inches (or larger or smaller), may be employed for feeding a smaller dog or a cat. The feeding receptacle 12 can be of any suitable shape, such as round, square, rectangular, hexagonal, and the like (see, for example, FIGS. 15-19), and of any suitable depth and contour. In one embodiment, the feeding device 12 can include a lower portion 16 (see also FIGS. 15 and 16, for example) that is made of a skid- or slip-resistant material, such as rubber or the like. Alternatively, as shown in FIG. 16, one or more skid- or slip-resistant pads may be adhesively secured to the bottom of the feeding device.

The feeding receptacle 12 includes a bottom wall 18 and an exterior sidewall 20 that define an interior cavity. As discussed above, the bottom wall 18 and exterior sidewall 20 can define an interior cavity of any of a variety of suitable shapes and sizes. The feeding receptacle generally can be formed of any of a number of materials, such as plastic, metal and the like. In one preferred construction, the receptacle is formed of a plastic or plastic-like material by way of injection molding.

The feeding receptacle 12 includes a rim 22 that extends around and outwardly from an upper portion of the sidewall 20. In one embodiment, the rim 22 includes a pair of flange portions 24 extending outwardly from opposite sides of the rim. Alternatively, the rim 22 can be of a substantially uniform lateral extent (shown, for example, in FIGS. 16-19). The rim and/or the flange portions can be of any suitable lateral dimension. In one embodiment, the flange portions are of sufficient lateral dimension to serve as handles for easy transport of the receptacle.

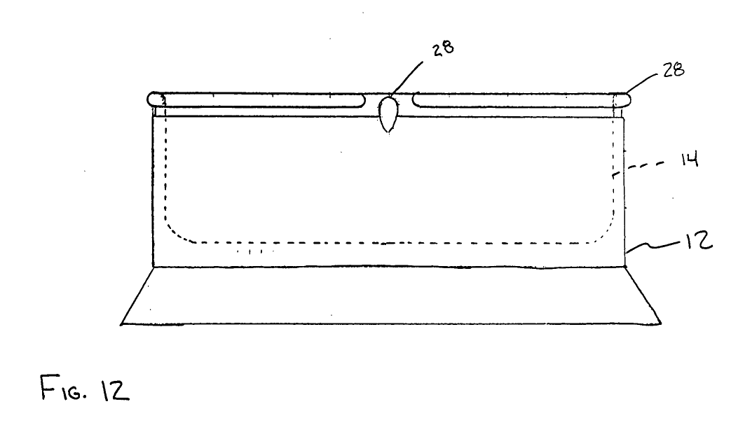

The receptacle 12 includes one or more, preferably a pair, of engagement members 8 (also referred to as protrusions or retaining members). The engagement members 28 extend upwardly from the flange portions 24 of the receptacle. In one embodiment, the engagement members 28 extend or protrude generally vertically from the flange portions 24. Alternatively, the engagement members 28 are angled inwardly. In one embodiment, the engagement members are angled inwardly by about 5 degrees to about 30 degrees. Such an angled orientation may be useful for convenient installation and removal of the disposable liners 14 retained thereon. In yet another embodiment, the engagement members 28 protrude outwardly from the sidewall 20 of the feeding receptacle (as shown in FIG. 9).

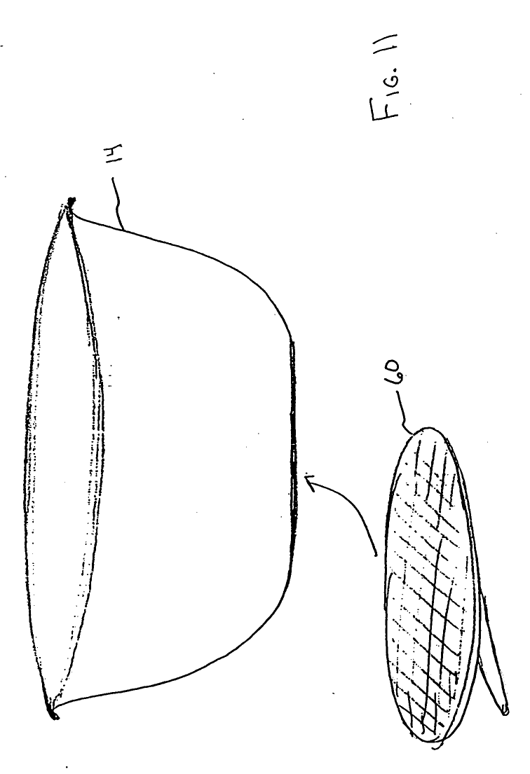

As illustrated in FIG. 4, each engagement member 28 includes a relatively narrow lower or stem portion 32 and a relatively wider upper or retention portion 34. In a preferred construction, the lower portion 32 of each engagement member 28 has a height of about 1 millimeter (or less depending upon the thickness of the liner being used) to about 5 millimeters (or more depending upon the thickness of the liner being used). Stated differently, the height of the lower portion 32 of each engagement member 28 facilitates having an upper portion 34 that is attached to, but displaced from, the flange portion 24 for enhanced retention of liners engaging the engagement members. FIG. 8 illustrates a plurality of suitable geometries for the engagement members 28. In an alternative embodiment, each engagement member includes an upper portion that is moveable between a position closer to the flange portion and a position vertically further from the flange portion. Adjustable engagement members can be provided using a telescoping lower portion or a lower portion that is slidably attached to the corresponding flange portion. In this construction, a liner can be installed on the engagement member, followed by the engagement member being lowered to contact and retain the liner disposed thereon.

In one embodiment, the engagement member 28 can include an aperture defined in the flange portion or sidewall of the feeding receptacle. As is discussed below, the engagement members 28 are constructed for releasably engaging disposable liners. It will be appreciated that engagement members having other geometries can be employed in order to releasably engage the liner 14 (see, for example, FIGS. 16-19).

The engagement members 28 should be formed in such a way as to be safe for animals. For example, sharp edges and/or corners (on which an animal could injure itself) should be avoided. In a preferred construction, the engagement members are integrally formed with the receptacle (e.g., as a single piece of plastic material). Alternatively, independent engagement members could be attached or otherwise coupled to flange portions of the feeding receptacle (without being formed integrally therewith).

The feeding system 10 includes a liner having a bottom wall 40 and sidewall 42 that define a food-receiving cavity. The bottom wall 40 and sidewall 42 can define a food-receiving cavity of any of a variety of suitable shapes and sizes. In a preferred construction, the size and shape of the liner 14 substantially conforms to the size and shape of the interior cavity of the feeding receptacle (as shown in several of the figures). In one embodiment, the liner can be formed of a somewhat flexible material that can be adapted to feeding receptacles of varying size and geometry. In one embodiment, “universal” liners can be employed such that they fit within or otherwise releasably engage feeding receptacles of varying size.

The liner generally is formed of a number of disposable, substantially liquid-resistant materials. In a preferred construction, the liner is formed of a substantially liquid-resistant, paper based material. Suitable materials include, but are not limited to paper, wax-coated paper, plastic-coated paper, rubber-coated paper, plastic and the like. In addition, the liner can be made from a material similar to materials from which human-usable cups or plates are made of (e.g., a paper or paper like material that has suitable strength and rigidity to controllably contain wet foods and liquids, while not disintegrating). The liner may also be formed of a lightweight polyethylene material, such as a low density polyvinyl chloride or like plastic. Such materials may, but do not have to, possess one or more of the following properties, being foldable, bendable, relatively crushable and disposable. In one embodiment, the liner can be formed of a biodegradable and environmentally benign material.

The liner should be made of a material that is non-toxic to animals, and preferably, the liner is made of a material that is “food grade” (i.e., suitable for safely containing food, human animal or otherwise). For example, if the animal were to chew on the liner, it should not present any toxicity to the animal.

The liner 14 includes a rim 46 that extends around and outwardly from an upper portion of the sidewall 42. In a preferred construction, the rim 46 includes a pair of flange portions 50 extending outwardly from opposite sides of the rim 46. Alternatively, the rim 46 can be of a substantially uniform lateral extent. The rim and/or flange portions can be of any suitable lateral dimension. In a preferred construction, the liner rim 46, including flange portions 50, does not extend outwardly beyond the outward extent of the feeding receptacle rim 22 and flange portions 24, respectively. In an alternative construction, the rim 46, with or without flange portions 50, can be larger and somewhat flexible in order to engage feeding receptacles of varying size and geometry.

The liner 14 includes one or more, preferably a pair, of engagement portions 52 (also referred to as retaining portions). In a preferred construction, the engagement portions 52 are formed in or otherwise defined by the flange portions 50. The engagement portions 52 can be of any suitable size and geometry (e.g., depending upon the size and geometry of the receptacle engagement members 28). FIG. 8 illustrates a plurality of suitable engagement portion geometries. In one embodiment, the engagement portions 52 include a center opening 54 surrounded by a plurality of punched or perforated areas 56. Alternatively, the engagement portions include only punched or perforated areas 56 without a center opening 54. The number and size of the perforated areas can be varied without departing from the scope of the present invention.

In each of the illustrated constructions, the engagement portions are formed to easily, releasably engage corresponding engagement members 28 on the receptacle 12. In one embodiment where the engagement member 28 is a hole or aperture (see, for example, the bottom illustration of FIG. 8), the liner engagement portion 52 includes a portion that can be pushed through the engagement member hole or aperture in order to achieve releasable engagement. In a variation of this embodiment, the engagement member 28 can include a perforated portion (e.g., a pseudo “star-shaped” portion) that engages the liner engagement portion when such engagement portion 52 is pushed into the engagement member 28.

FIG. 8 illustrates several exemplary embodiments in which the liner engagement portion 52 is sized or otherwise formed to selectively engage or otherwise cooperate with a feeding receptacle engagement member 28 of a certain size and geometry.

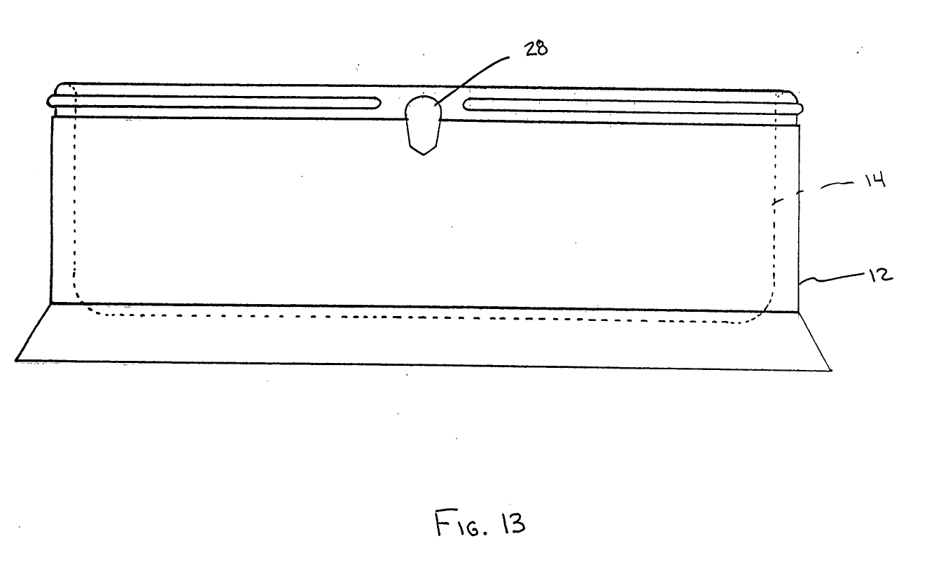

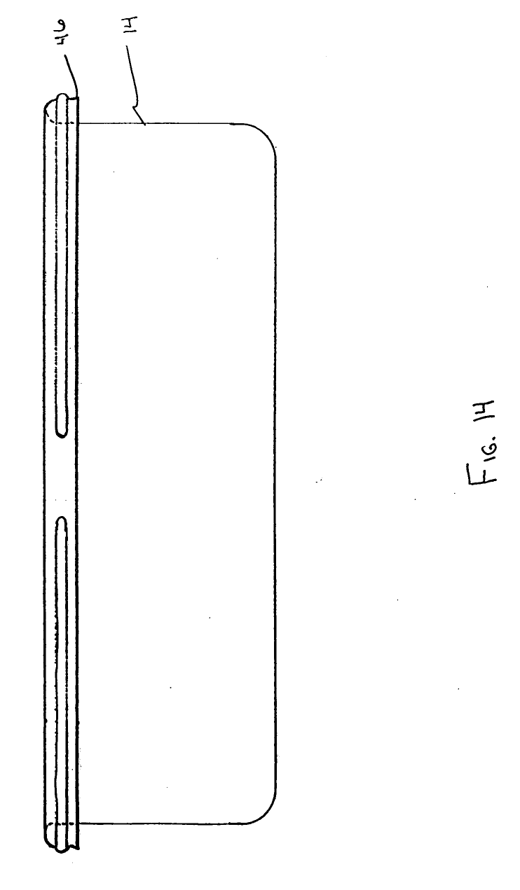

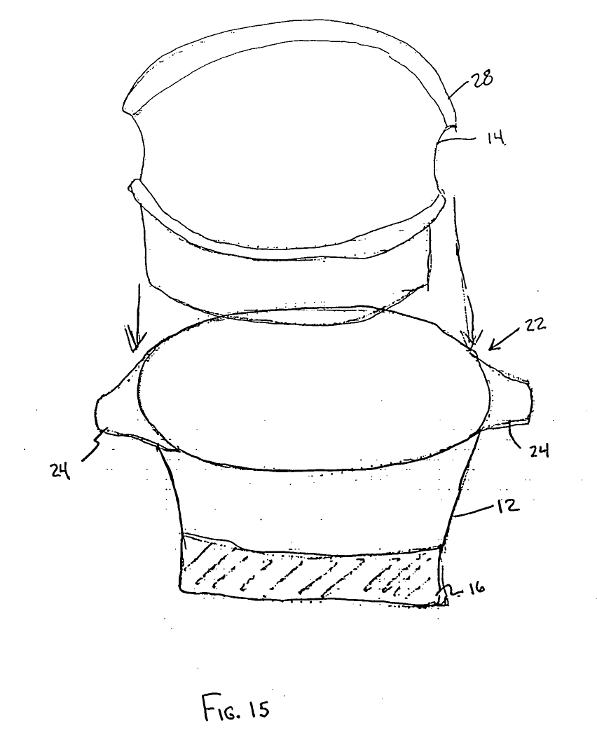

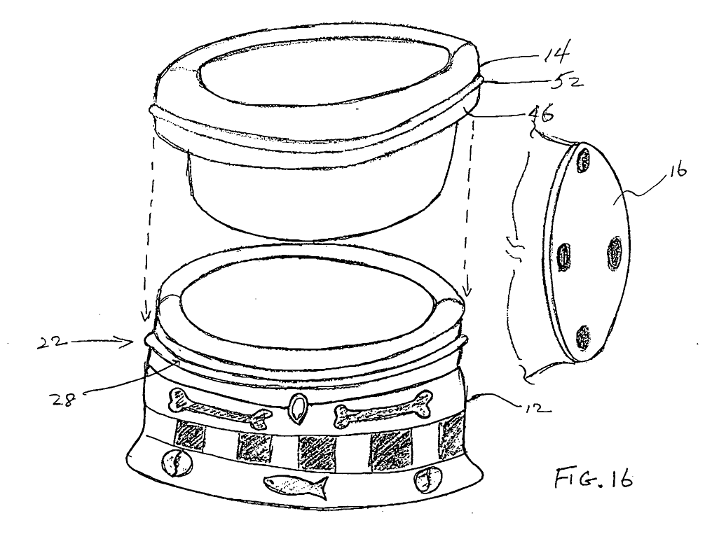

In another embodiment, the flange portions 50 of the liner can include a releasable adhesive on the undersides thereof for releasable engaging corresponding flange portions 24 of the feeding receptacle 12. Of course, the liner can be formed without a rim or flange and/or without its own engagement means and, in such an embodiment, can be affixed to the feeding device or another surface using a suitable releasable adhesive 60 (see FIG. 11, for example).

Other exemplary embodiments in accordance with aspects of the invention are illustrated in FIGS. 16-19. These include alternate engagement means for and between the liner and the feeding receptacle.

Although the invention has been shown and described with respect to certain illustrated embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention. In addition, while a particular feature of the invention may have been described above with respect to only one of several illustrated embodiments, such a feature may be combined with one or more other features of the other embodiment, as maybe desired and advantageous for any given or particular application.

What is claimed is:

1. A feeding system comprising:
a feeding receptacle having a bottom wall and a sidewall which define an internal cavity;
a rim around and extending outwardly from an upper portion of the sidewall; and
at least one engagement member attached to or formed with at least one of the sidewall and the rim.

2. The feeding system according to claim 1, wherein the rim includes a pair of flange portions extending outwardly from opposing sides of the rim.

3. The feeding system according to claim 2, wherein the at least one engagement member extends upwardly from at least one of the flange portions.

4. The feeding system according to claim 2, comprising an engagement member extending upwardly from each of the flange portions.

5. The feeding system according to claim 4, wherein each engagement member includes an upper portion and a lower portion, the upper portion having a larger lateral dimension than the lower portion.

6. The feeding system according to claim 5, wherein the upper portion of each engagement member is vertically movable relative to the flange portion.

7. The feeding system according to claim 4, wherein the engagement members are integrally formed with the flange portions.

8. The feeding system according to claim 4, wherein the engagement members are angled inwardly.

9. The feeding system according to claim 8, wherein the engagement members are angled inwardly between about 5 degrees and about 30 degrees.

10. The feeding system according to claim 5, further comprising a disposable liner releasably attached to the feeding receptacle.

11. The feeding system according to claim 10, wherein the disposable liner is sized to fit within the internal cavity of the feeding receptacle.

12. The feeding system according to claim 10, wherein the disposable liner includes:
a bottom wall and a sidewall which define an internal food-receiving cavity;
a rim around and extending outward from an upper portion of the liner sidewall; and
engagement portions for releasably engaging the engagement members of the feeding receptacle.

13. The feeding system according to claim 12, wherein the liner engagement portions are sized to pass over the upper portions of the engagement members and to be retained thereby.

14. The feeding system according to claim 12, wherein the engagement portions include a plurality of perforations.

15. The feeding system according to claim 12, wherein the engagement portions include an opening surrounded by a plurality of perforations.

16. The feeding system according to claim 12, wherein the liner is comprised of a substantially liquid-resistant, paper-based material.

17. The feeding system according to claim 16, wherein the liner is comprised of a wax-coated paper-based material.

18. The feeding system according to claim 12, wherein the liner rim includes a pair of flange portions extending outward from opposing sides of the liner rim.

19. The feeding system according to claim 18, wherein the engagement portions are disposed on each of the liner rim flange portions.

20. The feeding system according to claim 18, wherein the liner rim does not extend outwardly beyond the outward extent of the feeding receptacle rim.

21. A disposable liner for an animal feeding device, the liner comprising:
a bottom wall and a sidewall which define an internal cavity;
a rim around and extending outwardly from an upper portion of the sidewall, the rim including a pair of flange portions extending outwardly from opposing sides of the rim; and
a pair of engagement portions disposed within the flange portions.

22. The liner according to claim 21, wherein the engagement portions include a plurality of perforations.

23. The liner according to claim 21, wherein the engagement portions include an opening surrounded by a plurality of perforations.

24. The liner according to claim 22, wherein the liner is comprised of a substantially liquid-resistant, paper-based material.

25. The liner according to claim 21, wherein the engagement portions are configured to releasably engage engagement members extending upwardly from a feeding bowl.
